(19) United States
(12) Patent Application Publication
(10) Pub. No.: US 2026/0292144 A1
(43) Pub. Date: Sep. 24, 2026

(54) METHODS AND APPARATUS OF COMBINED PREDICTION MODE WITH EXTRAPOLATION INTRA PREDICTION FOR VIDEO CODING

(71) Applicant: MEDIATEK INC., Hsinchu City (TW)

(72) Inventors: Man-Shu CHIANG, Hsinchu City (TW); Chih-Wei HSU, Hsinchu City (TW)

(21) Appl. No.: 19/473,079

(22) PCT Filed: Oct. 17, 2024
(86) PCT No.: PCT/CN2024/125425

§ 371 Date: Oct. 6, 2025

Related U.S. Application Data
(60) Provisional application No. 63/591,792, filed on Oct. 20, 2023.

(51) Int. Cl. H04N 19/107; H04N 19/176

(52) U.S. Cl. CPC H04N 19/107; H04N 19/176

(57) ABSTRACT

A method and apparatus for video coding are disclosed. According to the method, input data associated with a current block is received, wherein the input data comprise pixel data to be encoded at an encoder side or coded data associated with the current block to be decoded at a decoder side. Mode-type prediction is determined, wherein the mode-type prediction is generated by using target prediction mode information from candidate prediction mode information, wherein the candidate prediction mode information comprises filter-based intra prediction information. Second prediction generated by an inter mode or an IBC (Intra Block Copy) mode is determined. Combined prediction is determined by using the mode-type prediction and the second prediction with blending weights. The current block is encoded or decoded using the combined prediction.

### CROSS REFERENCE TO RELATED APPLICATIONS

The present invention is a non-Provisional Application of and claims priority to U.S. Provisional Patent Application No. 63/591,792, filed on Oct. 20, 2023. The U.S. Provisional Patent Application is hereby incorporated by reference in its entirety.

### FIELD OF THE INVENTION

The present invention relates to video coding system. In particular, the present invention relates to deriving combined prediction including mode-type prediction and inter/IBC prediction with blending weight in a video coding system.

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology-Coded representation of immersive media-Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, is provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

Intra Mode Coding with 67 Intra Prediction Modes

To capture the arbitrary edge directions presented in natural video, the number of directional intra modes in VVC is extended from 33, as used in HEVC, to 65.

In VVC, several conventional angular intra prediction modes are adaptively replaced with wide-angle intra prediction modes for the non-square blocks.

### Intra Mode Coding

To keep the complexity of the Most Probable Mode (MPM) list generation low, an intra mode coding method with 6 MPMs (or called primary MPMs) is used by considering two available neighbouring intra modes. The following three aspects are considered to construct the MPM list:
Default intra modes
Neighbouring intra modes
Derived intra modes

### Wide-Angle Intra Prediction (WAIP) for Non-Square Blocks

Conventional angular intra prediction directions are defined from 45 degrees to −135 degrees in clockwise direction. In VVC, several conventional angular intra prediction modes are adaptively replaced with wide-angle intra prediction modes for non-square blocks.

To support these prediction directions, the top reference with length 2W+1, and the left reference with length 2H+1, are defined as shown in FIG. 2A and FIG. 2B.

### Decoder Side Intra Mode Derivation (DIMD)

When DIMD is applied, two intra modes are derived from the reconstructed neighbour samples (template), and those two predictors are combined with the planar mode predictor with the weights derived from the gradients. The DIMD mode is used as an alternative prediction mode and is always checked in the high-complexity RDO mode.

To implicitly derive the intra prediction modes of a block, a texture gradient analysis is performed at both encoder and decoder sides. This process starts with an empty Histogram of Gradient (HoG) with 65 entries, corresponding to the 65 angular modes. Amplitudes of these entries are determined during the texture gradient analysis.

In the first step, DIMD picks a template of T=3 columns and lines from respectively left and above current block. This area is used as the reference for the gradient based intra prediction modes derivation.

In the second step, the horizontal and vertical Sobel filters are applied on all 3×3 window positions, centered on the pixels of the middle line of the template. On each window position, Sobel filters calculate the intensity of pure horizontal and vertical directions as Gₓ and G_{y}, respectively. Then, the texture angle of the window is calculated as:

$$angle = arctan ( {G}_{x} / {G}_{y} ) , \qquad ( 1 )$$

which can be converted into one of 65 angular intra prediction modes. Once the intra prediction modes index of current window is derived as idx, the amplitude of its entry in the HoG[idx] is updated by addition of:

$$ampl = \vert {G}_{x} \vert + \vert {G}_{y} \vert \qquad ( 2 )$$

FIG. 3 shows an example of HoG, calculated after applying the above operations on all pixel positions in the template. FIG. 3A illustrates an example of selected template 320 for a current block 310. Template 320 comprises T lines above the current block and T columns to the left of the current block. For intra prediction of the current block, the area 330 at the above and left of the current block corresponds to a reconstructed area and the area 340 below and at the right of the block corresponds to an unavailable area. FIG. 3B illustrates an example for T=3 and the HoGs are calculated for pixels 360 in the middle line and pixels 362 in the middle column. For example, for pixel 352, a 3×3 window 350 is used. FIG. 3C illustrates an example of the amplitudes (ampl) calculated based on equation (2) for the angular intra prediction modes as determined from equation (1).

Once HoG is computed, the indices with two tallest histogram bars are selected as the two implicitly derived intra prediction modes (IPMs) for the block and are further combined with the Planar mode as the prediction of DIMD mode. The prediction fusion is applied as a weighted average of the above three predictors. To this aim, the weight of planar is fixed to 21/64 (~1/3). The remaining weight of 43/64 (~2/3) is then shared between the two HoG IPMs, proportionally to the amplitude of their HoG bars. FIG. 4 illustrates the DIMD process.

### Template-Based Intra Mode Derivation (TIMD)

Template-based intra mode derivation (TIMD) mode implicitly derives the intra prediction mode of a CU using a neighbouring template at both the encoder and decoder, instead of signalling the intra prediction mode to the decoder. As shown in FIG. 5, the prediction samples of the template (512 and 514) for the current block 510 are generated using the reference samples (520 and 522) of the template for each candidate mode. A cost is calculated as the SATD (Sum of Absolute Transformed Differences) between the prediction samples and the reconstruction samples of the template. The intra prediction mode with the minimum cost is selected as the TIMD mode (similar to the derivation for the DIMD mode) and used for intra prediction of the CU. The candidate modes may be 67 intra prediction modes as in VVC or extended to 131 intra prediction modes. In general, MPMs can provide a clue to indicate the directional information of a CU. Thus, to reduce the intra mode search space and utilize the characteristics of a CU, the intra prediction mode can be implicitly derived from the MPM list.

For each intra prediction mode in MPMs, the SATD between the prediction and reconstruction samples of the template is calculated. First two intra prediction modes with the minimum SATD are selected as the TIMD modes. These two TIMD modes are fused with weights after applying PDPC process, and such weighted intra prediction is used to code the current CU. Position dependent intra prediction combination (PDPC) is included in the derivation of the TIMD modes.

The costs of the two selected modes are compared with a threshold, in the test, the cost factor of 2 is applied as follows:

$$costMode 2 < 2 * costMode 1.$$

If this condition is true, the fusion is applied, otherwise only model is used. Weights of the modes are computed from their SATD costs as follows:

$$weight 1 = costMode 2 / ( costMode 1 + costMode 2 )$$

$$weight 2 = 1 - weight 1.$$

### Intra Sub-Partitions (ISP)

The intra sub-partitions (ISP) divides luma intra-predicted blocks vertically or horizontally into 2 or 4 sub-partitions depending on the block size. For each sub-partition, reconstructed samples are obtained by adding the residual signal to the prediction signal. Here, a residual signal is generated by the processes such as entropy decoding, inverse quantization and inverse transform. Therefore, the reconstructed sample values of each sub-partition are available to generate the prediction of the next sub-partition, and each sub-partition is processed repeatedly. In addition, the first sub-partition to be processed is the one containing the top-left sample of the CU and then continuing downwards (horizontal split) or rightwards (vertical split). As a result, reference samples used to generate the sub-partitions prediction signals are only located at the left and above sides of the lines. All sub-partitions share the same intra mode.

### Template Matching Prediction (TMP)

In JVET-V0130 and JVET-U0048, Template Matching Prediction (TMP) is disclosed. TMP is a special intra prediction mode that copies the best prediction block from the reconstructed part of the current frame, whose L-shaped template matches the current template. This is illustrated in FIG. 6, where block 610 is a current block and block 620 is a prediction block. For a predefined search range 630, the encoder searches for the most similar template 622 to the current template 612 in the reconstructed part 650 of the current frame 640, and uses the corresponding block 620 as a 20 prediction block (as a reference block). The encoder then signals the usage of this mode, and the inverse operation is made at the decoder side.

### Chroma Intra Mode Coding

Chroma mode coding directly depends on the intra prediction mode of the corresponding luma block. Since separate block partitioning structure for luma and chroma components is enabled in I slices, one chroma block may correspond to multiple luma blocks. Therefore, for Chroma DM mode, the intra prediction mode of the corresponding luma block covering the centre position of the current chroma block is directly inherited.

### An Extrapolation Filter-Based Intra Prediction (EIP) Mode

In JVET-AF0080 (Luhang Xu, et al., “EE2-2.7: An extrapolation filter-based intra prediction mode”, Joint Video Experts Team (JVET) of ITU-T SG 16 WP 3 and ISO/IEC JTC 1/SC 29, 32nd Meeting, Hannover, DE, 13-20 Oct. 2023, Document: JVET-AF0080), the extrapolation filter-based intra prediction is disclosed, where the EIP prediction is performed in three steps. First, the extrapolation filter coefficients are derived from a neighbouring reconstructed area of the current block or inherited from a previous EIP block. Second, the extrapolation process generates predicted signals from the top-left to bottom-right corner within the current block. Third, an intra prediction angle is derived by analysing the gradient of the predicted block, and then the corresponding intra-mode is used to select the MTS (Multiple Transform Selection), NSPT (Non-Separable Primary Transform) and LFNST (Low Frequency Non-Separable Transform) kernel for transformation.

The application of EIP is restricted to blocks with sizes not greater than 32×32 and the luma component only.

### Obtaining the EIP Filter

The three EIP filter shapes are shown in FIG. 7, where the three filter shapes correspond to square 710, horizontal strip 720, and vertical strip 730.

There are two ways to obtain the filter coefficients for the current CU according to JVET-AF0080. First, the coefficients can be derived from the neighbouring reconstructed pixels, and second, they can also be inherited from the previously decoded blocks.

### Derivation of EIP Coefficients

The decoder decodes the relevant syntax elements to determine the selected type of reconstructed area and the filter shape for the current block. The selected filter moves in the selected reconstructed area either horizontally or vertically with a one-pixel step to construct the auto-correlation matrix and the cross-correlation vector. The calculation of coefficients from the auto-correlation matrix and the cross-correlation vector is the same as that in convolutional cross-component model (CCCM).

The three types of the reconstructed area are defined as shown in FIG. 8, where the three reconstructed areas correspond to Left-Above area (FIG. 8A), Above area (FIG. 8B), and Left area (FIG. 8C). The size of the reconstructed area depends on the min (blockWidth, blockHeight) and the selected filter shape. For example, when the current block is an 8×16 block and the selected filter shape is 4×4. The aboveSize of the reconstructed area is equal to min (8, 16)+4−1=11, and the leftSize of the reconstructed area is equal to min (8, 16)+4−1=11.

### Inheritance of the EIP Filters

The EIP merge mode is also disclosed in JVET-AF0080. The filter shape and the filter coefficients can be inherited from the previous decoded blocks with EIP or EIP merge mode. The decoder decodes an EIP merge flag to decide whether the proposed merge mode is used when the current block uses the EIP mode. A merge index is further decoded when the EIP merge flag is true. The EIP merge list includes spatial adjacent and non-adjacent candidates, temporal candidates, and history candidates. The constructed EIP merge list can include up to 12 candidates and the list will be reduced to up to 6 candidates by the reordering process based on the SAD cost measured on an L-shape template with column width and row height equal to 1. In the SAD calculation, predictions of the template area by EIP filters are generated only from reconstructed (neighbouring and template) samples, allowing the EIP filters to be applied in parallel rather than sequentially.

### Prediction of the Current Block

The EIP mode generates prediction values for the current block from the top-left position to the bottom-right position by a diagonal prediction order, as shown in FIG. 9. The calculation for the prediction values in JVET-AF0080 is shown as follows,

$${pred}_{( x , y )} = {\sum }_{i = 0}^{14} ( {c}_{i} \times {t}_{( x - {offsetX}_{i} , y - {offsetY}_{i} )} )$$

where pred_{(x,y)} is the predicted value at (x, y) in the current block, cᵢ is the i^{th} coefficient of the selected EIP filter, the index of the coefficients is from 0 to 14, t_{(x-offsetX}_{ᵢ}_{,y-offsetY}_{ᵢ}₎ is a reconstructed or a predicted value used for the current position's prediction. offsetXᵢ and offsetYᵢ are the position offsets to the current position along x and y directions, respectively.

### Mapping to the LFNST/NSPT/MTS Set

In JVET-AF0080, a method is proposed to use the DIMD process to derive an intra prediction mode of the current block based on the EIP predicted samples. Specifically, a horizontal gradient and a vertical gradient are calculated for each predicted sample to build a histogram of gradient (HoG). Then the intra prediction mode corresponding to the largest histogram count is used to determine the LFNST, NSPT or MTS transform set.

### Proposed CU Level Syntax

The EIP related syntax is signalled at CU level. An example of EIP related syntax is shown in the following table.

TABLE 1
EIP related syntax at CU level

| | Descriptor |
|---|---|
| coding_unit( x0, y0, cbWidth, cbHeight, cqtDepth, | |
| treeType, modeType ) { | |
| ...... | |
| cu_eip_flag[x0][y0] | ae(v) |
| if(cu_eip_flag[x0][y0]){ | |
| eip_merge_flag[x0][y0] | ae(v) |
| if(eip_merge_flag[x0][y0]){ | |
| eip_merge_idx[x0][y0] | ae(v) |
| } | |
| else{ | |
| eip_mode_idx[x0][y0] // eip_mode_idx | ae(v) |
| represents the combination of the | |
| reconstruction area and the filter shape used | |
| to derive the EIP coefficients | |
| } | |
| } | |
| ...... | |
| } | |

### Enhanced MTS for Intra Coding

In the current VVC design, for MTS, only DST7 and DCT8 transform kernels are utilized which are used for intra and inter coding.

Additional primary transforms including DCT5, DST4, DST1, and identity transform (IDT) are employed. Also MTS set is made dependent on the TU size and intra mode information. For blocks predicted via IntraTMP (Intra Template Matching Prediction), DIMD process is used on the prediction block to derive an intra mode that is used for transform selection. Specifically, a horizontal gradient and a vertical gradient are calculated for each predicted sample to build a HoG. Then the intra prediction mode with the largest histogram amplitude value is used to the MTS transform set.

Secondary Transformation: LFNST Extension with Large Kernel

The LFNST design in VVC is extended as follows:
The number of LFNST sets(S) and candidates (C) are extended to S=35 and C=3, and the LFNST set (lfnstTrSetIdx) for a given intra mode (predModeIntra) is derived according to the following formula:
   For predModeIntra<2, lfnstTrSetIdx is equal to 2
   IfnstTrSetIdx=predModeIntra, for predModeIntra in [0,34]
   IfnstTrSetIdx=68-predModeIntra, for predModeIntra in [35,66]
Three different kernels, LFNST4, LFNST8, and LFNST16, are defined to indicate LFNST kernel sets, which are applied to 4×N/N×4 (N≥4), 8×N/N×8 (N≥8), and M×N (M, N≥16), respectively.

The mapping from intra prediction modes to these sets is shown in Table 2.

TABLE 2
Mapping of intra prediction modes to LFNST set index

| Intra pred. mode | −14 | −13 | −12 | −11 | −10 | −9 | −8 | −7 | −6 | −5 | −4 | −3 | −2 | −1 | 0 | 1 |
|---|---|---|---|---|---|---|---|---|---|---|---|---|---|---|---|---|
| LFNST set index | 2 | 2 | 2 | 2 | 2 | 2 | 2 | 2 | 2 | 2 | 2 | 2 | 2 | 2 | 0 | 1 |

| Intra pred. mode | 2 | 3 | 4 | 5 | 6 | 7 | 8 | 9 | 10 | 11 | 12 | 13 | 14 | 15 | 16 | 17 |
|---|---|---|---|---|---|---|---|---|---|---|---|---|---|---|---|---|
| LFNST set index | 2 | 3 | 4 | 5 | 6 | 7 | 8 | 9 | 10 | 11 | 12 | 13 | 14 | 15 | 16 | 17 |
| Intra pred. mode | 18 | 19 | 20 | 21 | 22 | 23 | 24 | 25 | 26 | 27 | 28 | 29 | 30 | 31 | 32 | 33 |
| LFNST set index | 18 | 19 | 20 | 21 | 22 | 23 | 24 | 25 | 26 | 27 | 28 | 29 | 30 | 31 | 32 | 33 |
| Intra pred. mode | 34 | 35 | 36 | 37 | 38 | 39 | 40 | 41 | 42 | 43 | 44 | 45 | 46 | 47 | 48 | 49 |
| LFNST set index | 34 | 33 | 32 | 31 | 30 | 29 | 28 | 27 | 26 | 25 | 24 | 23 | 22 | 21 | 20 | 19 |
| Intra pred. mode | 50 | 51 | 52 | 53 | 54 | 55 | 56 | 57 | 58 | 59 | 60 | 61 | 62 | 63 | 64 | 65 |
| LFNST set index | 18 | 17 | 16 | 15 | 14 | 13 | 12 | 11 | 10 | 9 | 8 | 7 | 6 | 5 | 4 | 3 |

| Intra pred. mode | 66 | 67 | 68 | 69 | 70 | 71 | 72 | 73 | 74 | 75 | 76 | 77 | 78 | 79 | 80 |
|---|---|---|---|---|---|---|---|---|---|---|---|---|---|---|---|
| LFNST set index | 2 | 2 | 2 | 2 | 2 | 2 | 2 | 2 | 2 | 2 | 2 | 2 | 2 | 2 | 2 |

For blocks using MIP (Matrix-based Intra Prediction) or IntraTMP prediction, the LFNST set index is derived as follows. DIMD is used to derive the intra prediction mode of the current block based on the MIP or IntraTMP predicted samples.

### Non-Separable Primary Transform (NSPT) for Intra Coding

The separable DCT-II plus LFNST transform combinations are replaced by NSPT for the block shapes 4×4, 4×8, 8×4 and 8×8, 4×16, 16×4, 8×16 and 16×8.

All NSPTs consist of 35 sets and 3 candidates (similar to the current LFNST). The kernels of NSPTs have the following shapes:
NSPT4×4: 16×16
NSPT4×8/NSPT8×4: 32×20
NSPT8×8: 64×32
NSPT4×16/NSPT16×4: 64×24
NSPT8×16/NSPT16×8: 128×40
NSPT4×32/NSPT32×4: 128×20
NSPT8×32/NSPT32×8: 256×24

Therefore, 12, 32, 40 and 88 coefficients are zeroed-out using NSPT4×8/NSPT8×4, NSPT8×8, NSPT4×16/NSPT16×4 and NSPT8×16/NSPT16×8 respectively. For NSPT4×32/NSPT32×4 and NSPT8×32/NSPT32×8, remaining 108 and 232 positions in each transform block are zeroed-out, respectively.

### Inter Prediction Overview

According to JVET-T2002. (Jianle Chen, et. al., “Algorithm description for Versatile Video Coding and Test Model 11 (VTM 11)”, Joint Video Experts Team (JVET) of ITU-T SG 16 WP 3 and ISO/IEC JTC 1/SC 29, 20th Meeting, by teleconference, 7-16 Oct. 2020, Document: JVET-T2002)), for each inter-predicted CU, motion parameters consist of motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU, which are obtained from neighbouring CUs, including spatial and temporal candidates, and additional schedules introduced in VVC. The merge mode can be applied to any inter-predicted CU, not only for skip mode. The alternative to the merge mode is the explicit transmission of motion parameters, where motion vector, corresponding reference picture index for each reference picture list and reference picture list usage flag and other needed information are signalled explicitly per each CU.

Beyond the inter coding features in HEVC, VVC includes a number of new and refined inter prediction coding tools listed as follows:
Extended merge prediction
Merge mode with MVD (MMVD)
Symmetric MVD (SMVD) signalling
Affine motion compensated prediction
Subblock-based temporal motion vector prediction (SbTMVP)
Adaptive motion vector resolution (AMVR)
Motion field storage: 1/16^{th} luma sample MV storage and 8×8 motion field compression
Bi-prediction with CU-level weight (BCW)
Bi-directional optical flow (BDOF)
Decoder side motion vector refinement (DMVR)
Geometric partitioning mode (GPM)
Combined inter and intra prediction (CIIP)

The following description provides the details of those inter prediction methods specified in VVC.

### Extended Merge Prediction

In VVC, the merge candidate list is constructed by including the following five types of candidates in order:
1) Spatial MVP from spatial neighbour CUs
2) Temporal MVP from collocated CUs
3) History-based MVP from an FIFO table
4) Pairwise average MVP
5) Zero MVs.

The size of merge list is signalled in sequence parameter set (SPS) header and the maximum allowed size of merge list is 6. For each CU coded in the merge mode, an index of best merge candidate is encoded using truncated unary binarization (TU). The first bin of the merge index is coded with context and bypass coding is used for remaining bins.

The derivation process of each category of the merge candidates is provided. As done in HEVC, VVC also supports parallel derivation of the merge candidate lists (or called as merging candidate lists) for all CUs within a certain size of area.

### Spatial Candidate Derivation

The derivation of spatial merge candidates in VVC is the same as that in HEVC except that the positions of first two merge candidates are swapped. A maximum of four merge candidates (B0, A0, B1 and A1) for current CU 1010 are selected among candidates located in the positions depicted in FIG. 10. The order of derivation is B0, A0, B1, A1 and B2. Position B2 is considered only when one or more neighbouring CU of positions B0, A0, B1, A1 are not available (e.g., belonging to another slice or tile) or is intra coded. After candidate at position A1 is added, the addition of the remaining candidates is subject to a redundancy check which ensures that candidates with the same motion information are excluded from the list so that coding efficiency is improved. To reduce computational complexity, not all possible candidate pairs are considered in the mentioned redundancy check. Instead, only the pairs linked with an arrow in FIG. 11 are considered and a candidate is only added to the list if the corresponding candidate used for redundancy check does not have the same motion information.

### Temporal Candidates Derivation

In this step, only one candidate is added to the list. Particularly, in the derivation of this temporal merge candidate for a current CU 1210, a scaled motion vector is derived based on the co-located CU 1220 belonging to the collocated reference picture as shown in FIG. 12. The reference picture list and the reference index to be used for the derivation of the co-located CU is explicitly signalled in the slice header. The scaled motion vector 1230 for the temporal merge candidate is obtained as illustrated by the dotted line in FIG. 12, which is scaled from the motion vector 1240 of the co-located CU using the POC (Picture Order Count) distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

The position for the temporal candidate is selected between candidates C0 and C1, as depicted in FIG. 13. If CU at position C0 is not available, is intra coded, or is outside of the current row of CTUs, position C1 is used. Otherwise, position C0 is used in the derivation of the temporal merge candidate.

### History-Based Merge Candidate Derivation

The history-based MVP (HMVP) merge candidates are added to merge list after the spatial MVP and TMVP. In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate.

The HMVP table size S is set to be 6, which indicates up to 5 History-based MVP (HMVP) candidates may be added to the table. When inserting a new motion candidate to the table, a constrained first-in-first-out (FIFO) rule is utilized wherein redundancy check is firstly applied to find whether there is an identical HMVP in the table. If found, the identical HMVP is removed from the table and all the HMVP candidates afterwards are moved forward, and the identical HMVP is inserted to the last entry of the table.

HMVP candidates could be used in the merge candidate list construction process. The latest several HMVP candidates in the table are checked in order and inserted to the candidate list after the TMVP candidate. Redundancy check is applied on the HMVP candidates to the spatial or temporal merge candidate.

To reduce the number of redundancy check operations, the following simplifications are introduced:
1. The last two entries in the table are redundancy checked to A1 and B1 spatial candidates, respectively.
2. Once the total number of available merge candidates reaches the maximally allowed merge candidates minus 1, the merge candidate list construction process from HMVP is terminated.

### Combined Inter and Intra Prediction (CIIP)

In VVC, when a CU is coded in merge mode, if the CU contains at least 64 luma samples (that is, CU width times CU height is equal to or larger than 64), and if both CU width and CU height are less than 128 luma samples, an additional flag is signalled to indicate if the combined inter/intra prediction (CIIP) mode is applied to the current CU. As its name indicates, the CIIP prediction combines an inter prediction signal with an intra prediction signal. The inter prediction signal in the CIIP mode Pᵢₙₜₑᵣ is derived using the same inter prediction process applied to regular merge mode; and the intra prediction signal Pᵢₙₜᵣₐ is derived following the regular intra prediction process with the planar mode. Then, the intra and inter prediction signals are combined using weighted averaging, where the weight value wt is calculated depending on the coding modes of the top and left neighbouring blocks (as shown in FIG. 14) of current CU 1410 as follows:
If the top neighbour is available and intra coded, then set isIntraTop to 1, otherwise set isIntraTop to 0;
If the left neighbour is available and intra coded, then set isIntraLeft to 1, otherwise set isIntraLeft to 0;
If (isIntraLeft+isIntraTop) is equal to 2, then wt is set to 3;
Otherwise, if (isIntraLeft+isIntraTop) is equal to 1, then wt is set to 2;
Otherwise, set wt to 1.

The CIIP prediction is formed as follows:

$${P}_{CIIP} = ( ( 4 - wt ) * {P}_{inter} + wt * {P}_{intra} + 2 ) ≫ 2$$

### Non-Adjacent Spatial Candidate

The non-adjacent spatial merge candidates as in JVET-L0399 (Yu Han, et al., “CE4.4.6: Improvement on Merge/Skip mode”, Joint Video Exploration Team (JVET) of ITU-T SG 16 WP 3 and ISO/IEC JTC 1/SC 29/WG 11, 12th Meeting: Macao, CN, 3-12 Oct. 2018, Document: JVET-L0399) are inserted after the TMVP in the regular merge candidate list. The pattern of spatial merge candidates is shown in FIG. 15. The distances between non-adjacent spatial candidates and current coding block are based on the width and height of current coding block. The line buffer restriction is not applied.

### Intra Block Copy (IBC)

Intra block copy (IBC) is a tool adopted in HEVC extensions on Screen Content Coding (SCC). It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. An IBC-coded CU is treated as the third prediction mode other than intra or inter prediction modes. The IBC mode is applicable to the CUs with both width and height smaller than or equal to 64 luma samples.

### Intra Template Matching

Intra template matching prediction (IntraTMP, similar to or same as TMP mentioned before) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side.

In the present invention, methods and apparatus to derive a combined predictor by blending mode-type prediction and inter/IBC prediction with blending weights for video coding are disclosed.

### BRIEF SUMMARY OF THE INVENTION

A method and apparatus for video coding are disclosed. According to the method, input data associated with a current block is received, wherein the input data comprise pixel data to be encoded at an encoder side or coded data associated with the current block to be decoded at a decoder side. Mode-type prediction is determined, wherein the mode-type prediction is generated by using target prediction mode information from candidate prediction mode information, wherein the candidate prediction mode information comprises filter-based intra prediction information. Second prediction generated by an inter mode or an IBC (Intra Block Copy) mode is determined. Combined prediction is determined by using the mode-type prediction and the second prediction with blending weights. The current block is encoded or decoded using the combined prediction.

In one embodiment, the candidate prediction mode information comprises mode type, prediction mode, or a combination thereof. In one embodiment, the mode type corresponds to intra mode and the prediction mode corresponds to DC, Planar, a directional mode, or an intra-related mode. In one embodiment, the intra-related mode comprises WAIP (Wide Angle Intra Prediction), MIP (Matrix-based Intra Prediction), Extrapolation Filter-based Intra Prediction (EIP) regular mode, EIP merge mode, an extension of EIP, or a combination thereof. In one embodiment, if a previous coded block is available, and the mode type, the prediction mode, pre-defined prediction mode information, or a combination thereof are supported, prediction mode information of the previous coded block is used as a candidate.

In one embodiment, the candidate prediction mode information is in a candidate list. In one embodiment, the candidate list corresponds to a merge candidate list. In one embodiment, the candidate list comprises one or more spatial adjacent candidates, one or more spatial non-adjacent candidates, one or more history candidates, one or more temporal candidates, one or more default candidates, or a combination thereof. In one embodiment, said one or more default candidates correspond to candidates containing default prediction mode information and/or being derived according to one or more existing candidates already put in the merge candidate list. In one embodiment, when inserting one candidate into the candidate list, full or partial pruning is used. In one embodiment, before adding said one candidate to the candidate list, all or subset of the candidate prediction mode information of said candidate is checked with corresponding prediction mode information of all or any subset of existing candidates already in the candidate list.

In one embodiment, one or more selected candidates are used to generate the mode-type prediction for the current block. In one embodiment, said one or more selected candidates are selected depending on template costs associated with available candidates. In one embodiment, the template costs are calculated based on distortion between reconstruction on a template and each candidate prediction on the template.

In one embodiment, the combined prediction corresponds to CIIP (Combined Inter and Intra Prediction).

In one embodiment, regression-based derivation is used to determine the blending weights. In one embodiment, the regression-based derivation estimates relationship between combined prediction of a reference region of the current block and reconstructed samples of the reference region of the current block to generate the blending weights according to the regression-based derivation. In one embodiment, the reference region of the current block varies with block width, block height, block area, signalled mode information of the current block, a neighbouring block, or a coded block, one or more syntax elements signalled in a block, CTU, SPS, PPS, picture, slice, tile, or sequence level, or a combination thereof.

In one embodiment, a flag is signalled to indicate whether said determining the combined prediction by using the mode-type prediction and the second prediction with blending weights and said encoding or decoding the current block using the combined prediction are used after the current block is already determined to code by a target mode.

In one embodiment, target combined prediction generated by using different blending weights is treated as an optional mode of combined prediction mode.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIGS. 2A-B illustrate the top reference with length 2W+1 and the left reference with length 2H+1 in order to support wide-angle prediction directions for a block with width much larger than height (FIG. 2A) and a block with height much larger than width (FIG. 2B).

FIG. 3A illustrates an example of selected template for a current block, where the template comprises T lines above the current block and T columns to the left of the current block.

FIG. 3B illustrates an example for T=3 and the HoG (Histogram of Gradient) is calculated for pixels in the middle line and pixels in the middle column.

FIG. 3C illustrates an example of the amplitudes (ampl) for the angular intra prediction modes.

FIG. 4 illustrates an example of the blending process, where two angular intra modes (M1 and M2) are selected according to the indices with two tallest bars of histogram bars.

FIG. 5 illustrates an example of template-based intra mode derivation (TIMD) mode, where TIMD implicitly derives the intra prediction mode of a CU using a neighbouring template at both the encoder and decoder.

FIG. 6 illustrates an example of Template Matching Prediction (TMP).

FIG. 7 illustrates three types of filter shapes with fifteen inputs and generate one output for EIP process.

FIGS. 8A-C illustrate three types (FIG. 8A: Left-Above area, FIG. 8B: Above area, and FIG. 8C: Left area) of reconstructed areas used to derive filter coefficients for EIP.

FIG. 9 illustrates an example of scanning order for generating predictions for different positions in the current block by a diagonal order.

FIG. 10 illustrates the neighbouring blocks used for deriving spatial merge candidates for VVC.

FIG. 11 illustrates the possible candidate pairs considered for redundancy check in VVC.

FIG. 12 illustrates an example of temporal candidate derivation, where a scaled motion vector is derived according to POC (Picture Order Count) distances.

FIG. 13 illustrates the position for the temporal candidate selected between candidates C₀ and C₁.

FIG. 14 illustrates an example of the weight value derivation for Combined Inter and Intra Prediction (CIIP) according to the coding modes of the top and left neighbouring blocks.

FIG. 15 illustrates an exemplary pattern of the spatial merge candidates.

FIG. 16 illustrates an example of the spatial neighbouring region of the current block includes above reference region, left reference region, and above-left reference region for deriving the weighting setting.

FIG. 17 illustrates a flowchart of an exemplary video coding system that derives a combined predictor by blending mode-type prediction and inter/IBC prediction with blending weights according to an embodiment of the present invention.

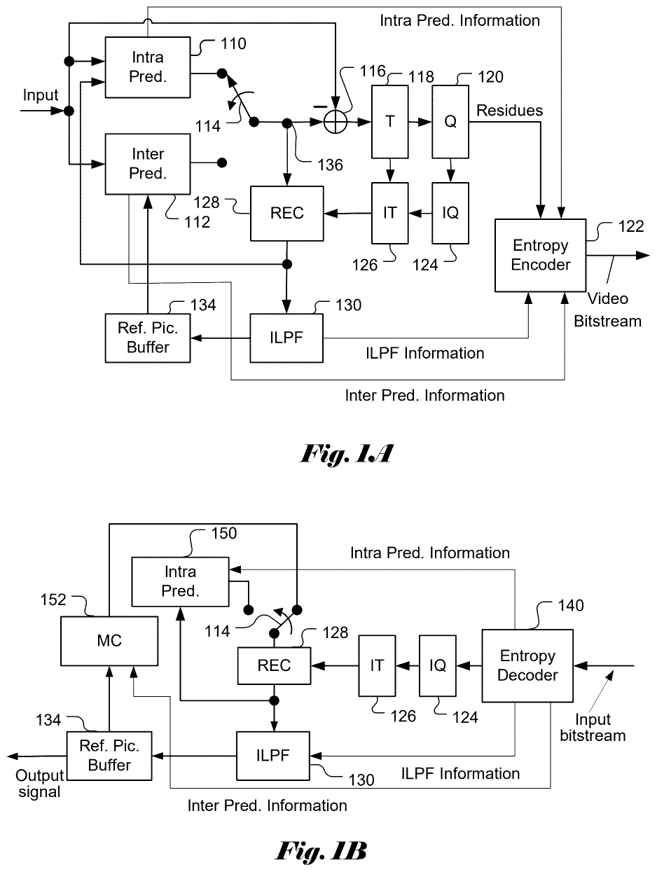

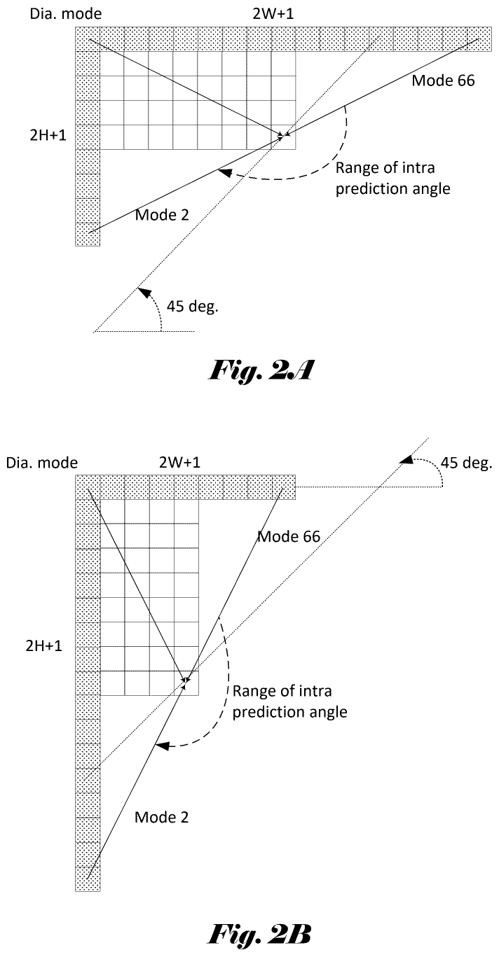

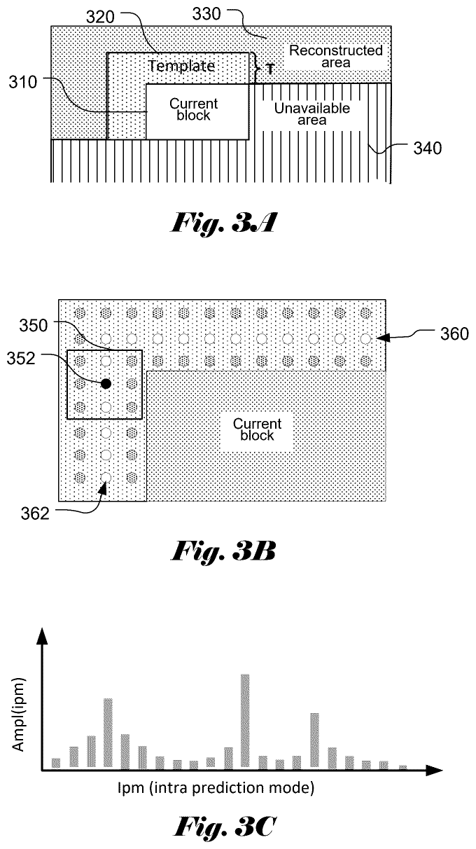

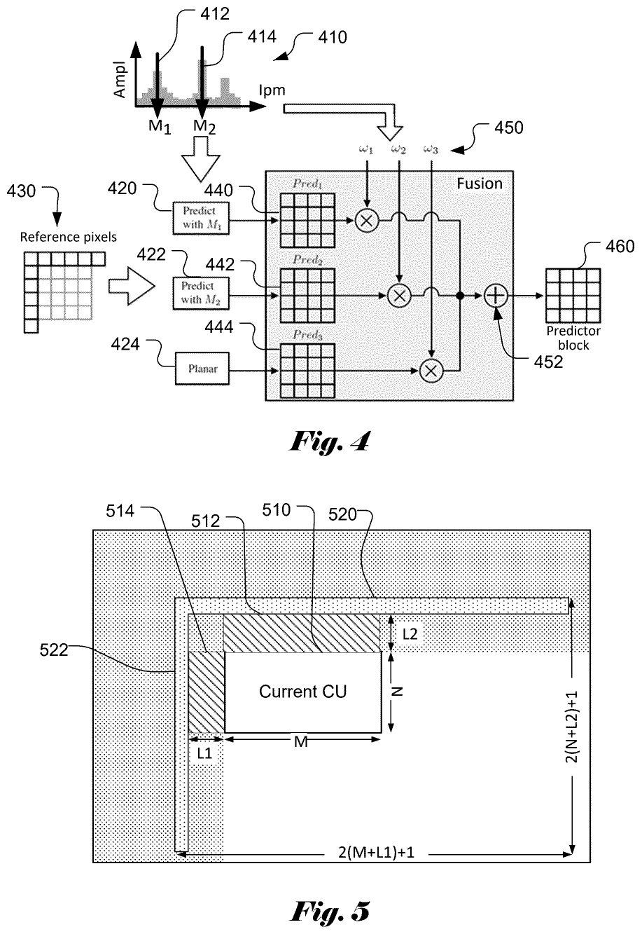

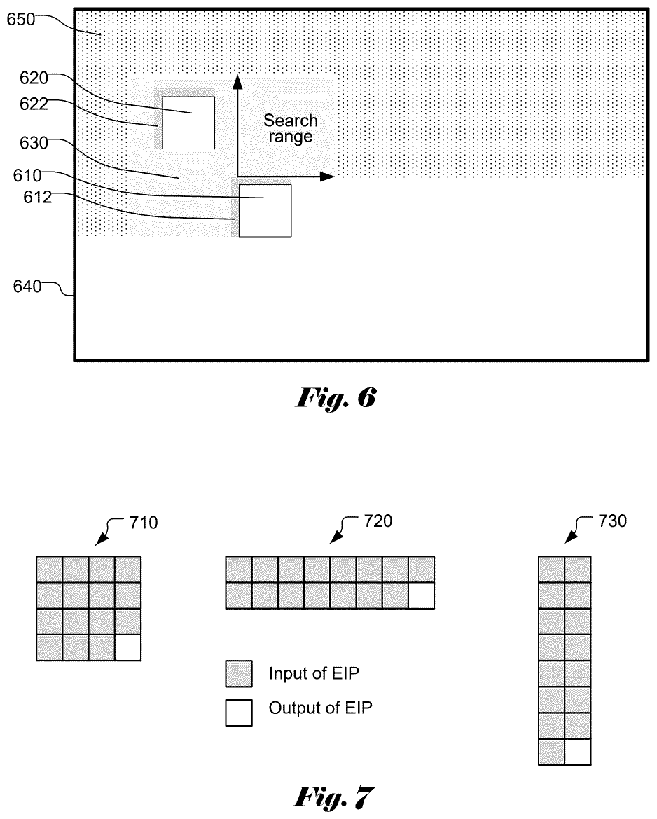

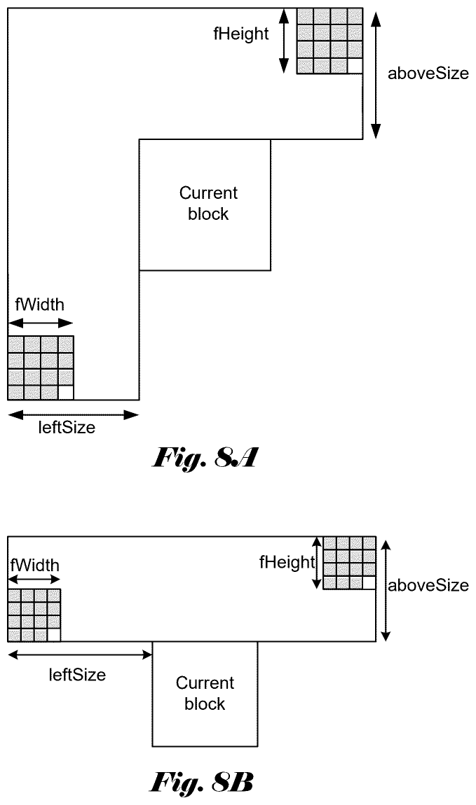

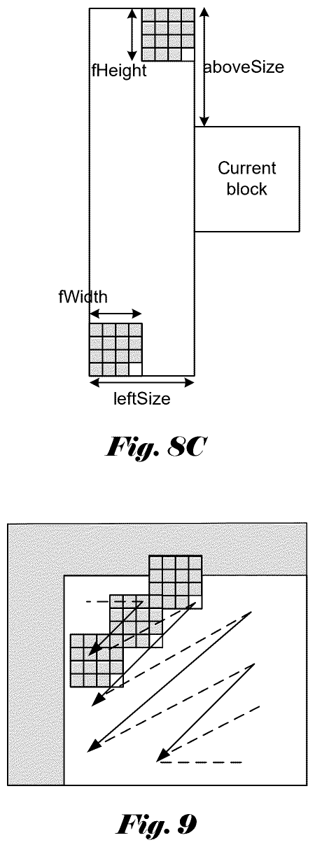

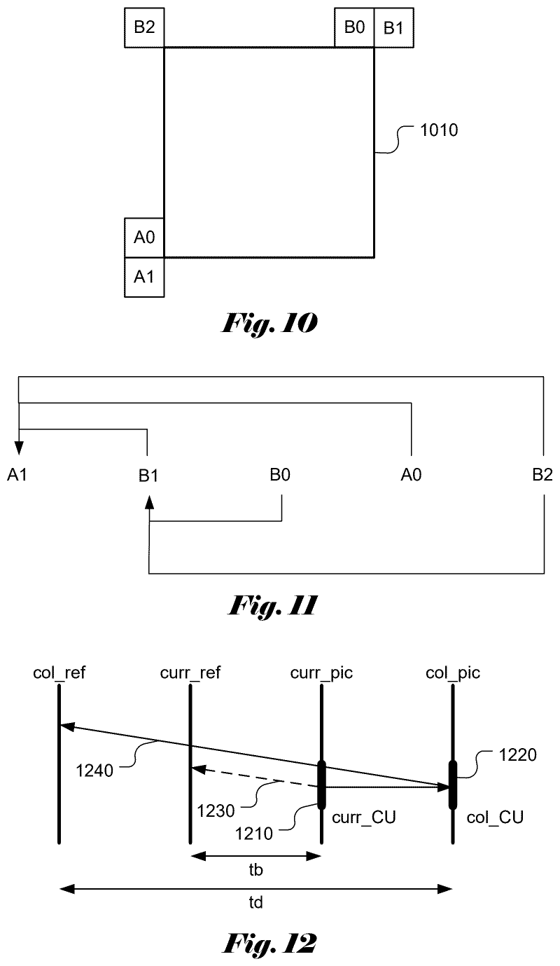

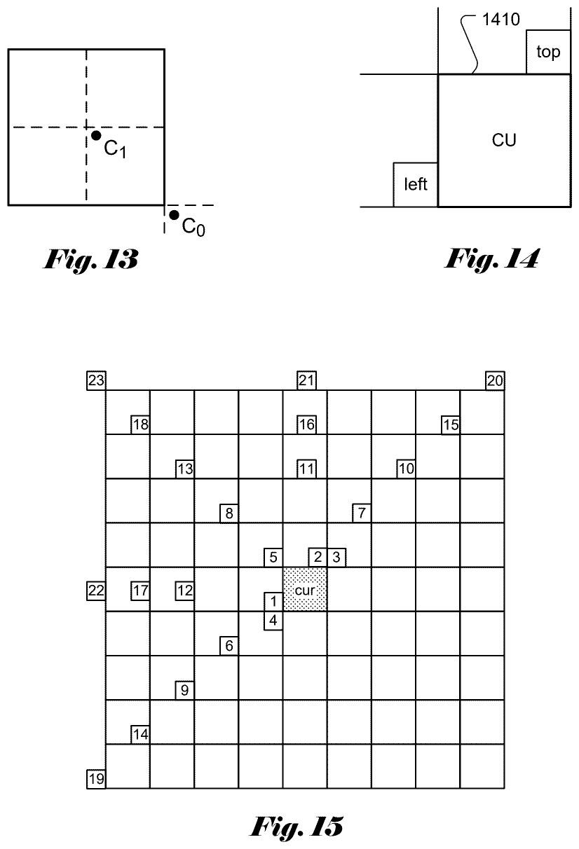

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

In order to improve coding performance, a combined predictor by blending mode-type prediction and inter/IBC prediction with blending weight is disclosed.

In this invention, the following aspects are proposed to improve combined prediction. In one embodiment, the combined prediction is formed by using a mode-type (e.g. intra) prediction and inter prediction with blending weighting. For example, the combined prediction is from a CHIP mode. In another embodiment, the mode-type prediction is generated using target prediction mode information, for example, filter-based intra prediction information such as information of extrapolation filter-based intra prediction (EIP). For example, the mode-type prediction can be generated using any pre-defined mode in extrapolation filter-based intra prediction such as an EIP regular mode (i.e. non-merge EIP mode) with the EIP mode index equal to a pre-defined value where the pre-defined value is fixed at 0 or adaptive according to the block position, block width, block height, and/or block area of the current block. For another example, the mode-type prediction is generated using any pre-defined mode in extrapolation filter-based intra prediction such as a EIP merge mode with the EIP merge index equal to a pre-defined value where the pre-defined value is fixed at 0 (i.e. the EIP merge mode at the front of the re-ordered or not-re-ordered EIP merge list) or adaptive according to the block position, block width, block height, and/or block area of the current block.

In another embodiment, the mode-type prediction in the combined prediction is generated by said one or more sets of prediction mode information suggested according to template-based mode derivation process, for example, TIMD process. In another embodiment, the inter prediction here can be replaced with any pre-defined block-vector prediction if the proposed methods are applied to the target mode referring to IBC or intraTMP. Several aspects are proposed in the following. Section I is related to the candidate list for suggestion. Section II is related to how to generate the mode-type prediction according to said one or more sets of prediction mode information from suggestion. Section III is related to the combined prediction and signalling.

### I. Candidate List for Suggestion

The candidate list for suggestion which may be similar to TIMD is generated according to prediction mode information of the previous coded blocks and/or default prediction mode information. The prediction mode information includes or only includes mode-type, prediction mode, and/or any subset of above. In one embodiment, the candidate list here is aligned with the MPM list or any merge list for regular intra mode. For Example-1, the prediction mode information refers to the mode type equal to intra and the prediction mode equal to DC, PL, any directional mode, any intra prediction modes in the related art (i.e. WAIP or MIP), any intra prediction scheme in the standard (i.e. EIP including EIP regular modes, EIP merge modes, any subset/extension of the above-mentioned modes), or a combination thereof. For Example-2, the prediction mode information refers to the mode type equal to intraTMP and the prediction mode indicating block vectors obtained by searching in a pre-defined region using template matching. For Example-3, the prediction mode information refers to mode type equal to IBC and the prediction mode indicating block vectors. When (1) a previous coded block is available and (2) the mode-type and/or the prediction mode and/or any pre-defined prediction mode information of the previous coded block is supported by the mode using the proposed combining prediction, the prediction mode information of the previous coded block is valid and can be inserted into the candidate list here as a candidate. In one embodiment, all of Example-1, Example-2, and Example-3 are supported by the mode using the proposed combined prediction. In another embodiment, any subset of Example-1, Example-2, and Example-3 are supported by the mode using the proposed combined prediction.

In another embodiment, the candidate list here can be all or any subset of the MPM list or any merge list for regular intra mode. That means all or any subset of the previous coded blocks checked in construction of MPM list or any merge list for regular intra mode will be checked in construction of the candidate list here. In another embodiment, the candidate list here which refers to a merge candidate list, containing candidates with prediction mode information, is built for the current block. As what regular inter merge mode does, the merge candidate list includes the candidates of spatial adjacent candidates, non-adjacent candidates, history candidates, temporal candidates, default candidates, or any subset of above-mentioned candidates. The spatial adjacent candidates are from the adjacent neighbouring blocks of the current block where the adjacent neighbouring blocks can be the same as the 5 spatial neighbouring blocks for regular inter merge mode or any subset of the adjacent neighbouring blocks of the current block. The non-adjacent candidates are from a search range around (but not adjacent to) the current block. The search range can be the same as the search range of non-adjacent candidates for regular inter merge mode or different search range of the current block.

The history candidates are selected from a history-based buffer array. In the history-based buffer array, the prediction mode information of each valid previous coded block is stored where the valid previous coded block refers to any block containing supported prediction mode information (e.g. (1) information associated with mode type such as intraTMP, IBC, or a combination of above and/or information associated with prediction mode such as block vectors and/or (2) information associated with mode type as intra and/or information associated with prediction mode as EIP regular modes, EIP merge modes, or a combination of above). Like what history candidates in the merge list of regular inter merge mode, the first stored information may be removed for including the information associated with the latest valid coded block if the buffer array is full. The buffer array is cleaned up (or emptied) at the beginning or the end of a pre-defined unit. The pre-defined unit can be a CTU, CTU row, slice, tile, picture, or any pre-defined region. In one sub-embodiment, the merge candidate list refers to the history buffer array only. That is, only history candidates are included and/or will not use the candidates from a far non-adjacent region. The temporal candidates are obtained from the prediction mode information stored in one or more pre-defined previous coded picture if the stored information is valid. In one sub-embodiment, the temporal candidates are only available for inter slices which may have the pre-defined previous coded picture as the collocated picture as the regular inter merge flow.

In one embodiment, the default candidates are the candidates containing default (valid) prediction mode information and/or derived according to the candidates already put in the merge candidate list. In another embodiment, the merge candidate list here is aligned with or can be any subset of the merge candidate list for regular inter merge mode. In another embodiment, full or partial pruning is used to avoid duplicated prediction mode information in the list. Before adding a candidate in the list, all or subset of prediction mode information of the to-be-added candidate is checked with the corresponding prediction mode information of all or any subset candidates already in the list. All prediction mode information refers to all stored prediction mode information (e.g. the mode type and/or prediction mode). The subset of prediction mode information can be only mode type or only prediction mode or any pre-defined subset from all.

### II. Generation of Mode-Type Prediction

The selection depends on implicitly or explicitly selecting one or more (K) candidates from the candidate list in Section I. After the selection, the one or more selected candidates are used to generate the mode-type prediction for the current block. If the mode types in Example-1, Example-2, and/or Example-3 are all supported and K>1, the mode type prediction can be intra (i.e. EIP)+intra (i.e. EIP), and/or intra (i.e. EIP)+intraTMP and/or intra (i.e. EIP)+IBC. If the mode types in Example-1, Example-2, and/or Example-3 are all supported and K=1, the mode type prediction can be intra (i.e. EIP), and/or intraTMP and/or IBC. In one embodiment, the selection depends on the template costs like TIMD. That means each candidate in the list generates the prediction on the template to get the template prediction such as predicted template and the template cost for each candidate is measured according to the distortion between the predicted template and reconstructed template. The candidate list is reordered according to the costs and/or the promising candidates with smaller costs are recorded. In another embodiment, the selection uses the first K candidate in the candidate list. When K is 1, the only one selected candidate is used to generate the mode-type prediction for the current block. When K is larger than 1, multiple hypotheses of prediction with each hypothesis generated by one selected candidate are used to form the mode-type prediction by a pre-defined weighting. In one embodiment, the pre-defined weighting follows the costs. For the prediction generated by the candidate with a higher cost, the weight for this prediction gets smaller.

### III. Combined Prediction and Signalling

After determining the mode-type prediction in Section II, the combined prediction is formed by using weighted averaging.

In one embodiment, if the mode using the combined prediction is CIIP, the weighted averaging follows the weighting used to combine with inter prediction in CIIP.

In another embodiment, the weighted average follows template costs such as TIMD. The weight for the hypothesis of prediction (either mode-type prediction or inter prediction) with a smaller template cost has a larger value.

In another embodiment, weights in the weighted average are derived using a regression-based derivation. The proposed weight setting to decide the weights is to estimate the relationship (e.g. minimizing the distortion) between the combining results (e.g. combined prediction) and the reconstructed samples on the reference region of the current block by a pre-defined regression method. A weighting (which may refer to model parameters) is then generated according to the regression method, and then to apply the weighting to derive the target (predicted) samples in the current block. In one embodiment, the pre-defined regression method can be linear minimum mean square error (LMMSE) method as for cross-component linear model (CCLM) or can be any unified method with the regression method used for CCLM. In another embodiment, the pre-defined regression method can be the LDL decomposition method as for CCCM or can be any unified method with the regression method used for CCCM. In another embodiment, the pre-defined regression method can be Gaussian elimination.

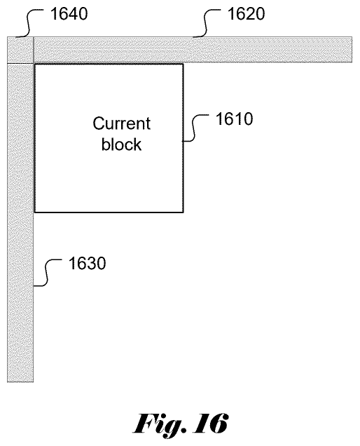

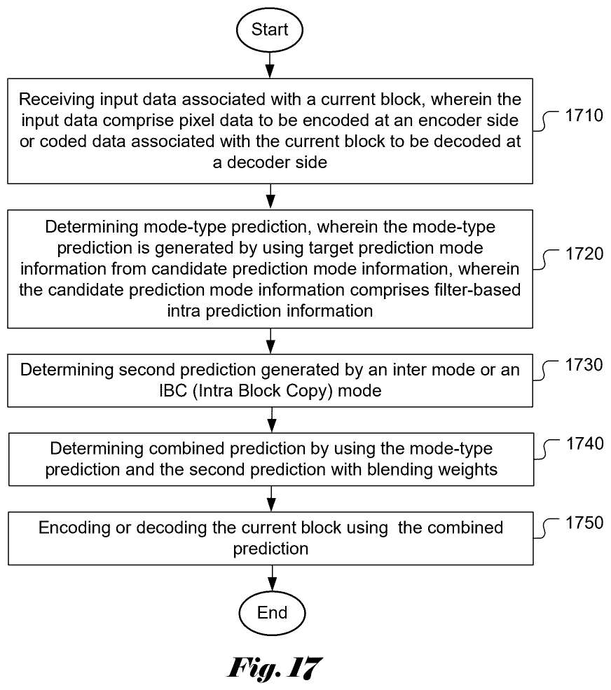

In one sub-embodiment, the reference region of the current block is the spatial neighbouring region of the current block, which may include only the spatial adjacent neighbouring region of the current block, only the spatial non-adjacent neighbouring region of the current block, both the spatial adjacent and non-adjacent neighbouring regions of the current block, and/or any pre-defined coded region. The reference region of the current block can vary with the block width, block height, block area, the signalling mode information of the current block, the signalling mode information of any neighbouring blocks and/or any coded blocks, and/or syntax elements on block, CTU, SPS, PPS, picture, slice, tile, and/or sequence level. The spatial neighbouring region of the current block 1610 includes above reference region 1620, left reference region 1630, above-left reference region 1640, and/or any subset of the above as shown in FIG. 16. The size of the above reference region is A_{W}×A_{H}, the size of the left reference region is L_{W}×L_{H}, and the size of the above-left reference region is AL_{W}×AL_{H}, where
A_{W}=block width of the current block (W), k*W, W+block height of the current block (H), any pre-defined value, or any adaptive value depending on the block position, block width, block height, and/or block area of the current block.
A_{H} or AL_{H}=H, any pre-defined value (e.g. 1, 2, 4, . . . ), or any adaptive value depending on the block position, block width, block height, and/or block area of the current block.
L_{W} or AL_{W}=W, any pre-defined value (e.g. 1, 2, 4, . . . ), or any adaptive value depending on the block position, block width, block height, and/or block area of the current block.
L_{H}=H, k*H, H+W, any pre-defined value, or any adaptive value depending on the block position, block width, block height, and/or block area of the current block.

In this example, the reference region is spatially adjacent to the current block. In other cases, the reference region may be spatially adjacent to the collocated block of the current block.

In one embodiment, the proposed combined prediction is used to replace the combined prediction in current CIIP design. That means when the enabling flag for CIIP indicates to apply CHIP to the current block, the proposed method is inferred to generate the final prediction of CIIP. In another embodiment, one additional flag is signalled to indicate whether the proposed combined prediction is used after the current block is already determined to code by a target mode. For example, the target mode is CIIP and/or the existing enabling flag of CIIP indicates that CIIP is applied to the current block. In another embodiment, the inter prediction used in the proposed combined prediction should be merge prediction, AMVP (advanced MVP) prediction, or merge prediction added with AMVP prediction. For another example, the target mode can be any mode mentioned in the related art such as CIIP, GPM, any GPM variations, IBC, and/or intraTMP. In another embodiment, after determining to use the proposed combined prediction for the current block, different weighting methods can be treated as different optional modes of the combined prediction mode. An implicit rule and/or an explicit mode index indication is used to select the optional mode of the combined prediction for the current block. For example, Option 1 uses fixed weighting to combine and/or Option 2 uses regression weighting to combine.

In one embodiment, the proposed methods in this invention can be enabled and/or disabled according to implicit rules (e.g. block width, height, or area) or according to explicit rules (e.g. syntax on block, tile, slice, picture, SPS, or PPS level). For example, the proposed method is applied when the block area is smaller/larger than a threshold. In another embodiment, the proposed method uses the DIMD process to derive an intra prediction mode of the current block based on the used predicted samples, such as all or any subset of the combined predicted samples and/or intermediate predicted samples (i.e. any hypothesis of prediction, which will be used to form the combined prediction) before combining predicted samples. In this case, a horizontal gradient and a vertical gradient are calculated for each used predicted sample to build a histogram of gradient (HoG). Then, the intra prediction mode corresponding to the largest histogram count is used to determine the transform set in the transform process of the current block and/or the coding process of the following coding blocks.

In one example, the transform process of the current block can be LFNST, NSPT, and/or MTS. Note that in this invention, LFNST/NSPT/MTS can be used in the transform process for only intra blocks, for only inter blocks, or only for a third type (not intra and not inter) blocks, and/or for any subset or combination of the above. For another example, the coding process of the following coding blocks can refer to the MPM (or merge list) construction and/or any inheritance scheme of the following coding block. When the following coding blocks reference (or inherit) the intra prediction mode of the current block, the derived intra prediction mode of the current block can be referenced. For another example, in the case of the current block being luma and the following coding block being chroma, the chroma DM of the following coding block can use the derived intra prediction mode of the current block if the current block is the collocated luma block of the following coding chroma block.

The term “block” in this invention can refer to TU/TB, CU/CB, PU/PB, pre-defined region, or CTU/CTB.

Any combination of the proposed methods in this invention can be applied.

Any of the foregoing proposed methods of deriving combined prediction by using the mode-type prediction and a second prediction with blending weights can be implemented in encoders and/or decoders. For example, any of the proposed methods can be implemented in an inter/intra/IBC/prediction/transform module an of encoder, and/or an inter/intra/IBC/prediction/transform module of a decoder. Alternatively, any of the proposed methods can be implemented as a circuit coupled to the inter/intra/IBC/prediction/transform module of the encoder and/or the inter/intra/IBC/prediction/transform module of the decoder, so as to provide the information needed by the inter/intra/IBC/prediction/transform module.

FIG. 17 illustrates a flowchart of an exemplary video coding system that derives a combined predictor by blending mode-type prediction and inter/IBC prediction with blending weights according to an embodiment of the present invention. The steps shown in the flowchart may also be implemented based on hardware such as one or more electronic devices or processors arranged to perform the steps in the flowchart. According to the method, input data associated with a current block is received in step 1710, wherein the input data comprise pixel data to be encoded at an encoder side or coded data associated with the current block to be decoded at a decoder side. Mode-type prediction is determined in step 1720, wherein the mode-type prediction is generated by using target prediction mode information from candidate prediction mode information, wherein the candidate prediction mode information comprises filter-based intra prediction information. Second prediction generated by an inter mode or an IBC (Intra Block Copy) mode is determined in step 1730. Combined prediction is determined by using the mode-type prediction and the second prediction with blending weights in step 1740. The current block is encoded or decoded using the combined prediction in step 1750.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving input data associated with a current block, wherein the input data comprise pixel data to be encoded at an encoder side or coded data associated with the current block to be decoded at a decoder side;
determining mode-type prediction, wherein the mode-type prediction is generated by using target prediction mode information from candidate prediction mode information, wherein the candidate prediction mode information comprises filter-based intra prediction information;
determining second prediction generated by an inter mode or an IBC (Intra Block Copy) mode;
determining combined prediction by using the mode-type prediction and the second prediction with blending weights; and
encoding or decoding the current block using the combined prediction.

2. The method of claim 1, wherein the candidate prediction mode information comprises mode type, prediction mode, or a combination thereof.

3. The method of claim 2, wherein the mode type corresponds to intra mode and the prediction mode corresponds to DC, Planar, a directional mode, or an intra-related mode.

4. The method of claim 3, wherein the intra-related mode comprises WAIP (Wide Angle Intra Prediction), MIP (Matrix-based Intra Prediction), Extrapolation Filter-based Intra Prediction (EIP) regular mode, EIP merge mode, an extension of EIP, or a combination thereof.

5. The method of claim 2, wherein if a previous coded block is available, and the mode type, the prediction mode, pre-defined prediction mode information, or a combination thereof are supported, prediction mode information of the previous coded block is used as a candidate.

6. The method of claim 1, the candidate prediction mode information is in a candidate list.

7. The method of claim 6, wherein the candidate list corresponds to a merge candidate list.

8. The method of claim 7, wherein the candidate list comprises one or more spatial adjacent candidates, one or more spatial non-adjacent candidates, one or more history candidates, one or more temporal candidates, one or more default candidates, or a combination thereof.

9. The method of claim 8, wherein said one or more default candidates correspond to candidates containing default prediction mode information and/or being derived according to one or more existing candidates already put in the merge candidate list.

10. The method of claim 6, wherein when inserting one candidate into the candidate list, full or partial pruning is used.

11. The method of claim 10, wherein before adding said one candidate to the candidate list, all or subset of the candidate prediction mode information of said candidate is checked with corresponding prediction mode information of all or any subset of existing candidates already in the candidate list.

12. The method of claim 1, wherein one or more selected candidates are used to generate the mode-type prediction for the current block.

13. The method of claim 12, wherein said one or more selected candidates are selected depending on template costs associated with available candidates.

14. The method of claim 13, wherein the template costs are calculated based on distortion between reconstruction on a template and each candidate prediction on the template.

15. The method of claim 1, wherein the combined prediction corresponds to CHIP (Combined Inter and Intra Prediction).

16. The method of claim 15, wherein regression-based derivation is used to determine the blending weights.

17. The method of claim 16, wherein the regression-based derivation estimates relationship between combined prediction of a reference region of the current block and reconstructed samples of the reference region of the current block to generate the blending weights according to the regression-based derivation.

18. The method of claim 17, wherein the reference region of the current block varies with block width, block height, block area, signalled mode information of the current block, a neighbouring block, or a coded block, one or more syntax elements signalled in a block, CTU, SPS, PPS, picture, slice, tile, or sequence level, or a combination thereof.

19. The method of claim 15, wherein a flag is signalled to indicate whether said determining the combined prediction by using the mode-type prediction and the second prediction with the blending weights and said encoding or decoding the current block using the combined prediction are used after the current block is already determined to code by a target mode.

20. The method of claim 1, wherein target combined prediction generated by using different blending weights is treated as an optional mode of combined prediction mode.

21. An apparatus for video coding, the apparatus comprising one or more electronics or processors arranged to:
receive input data associated with a current block, wherein the input data comprise pixel data to be encoded at an encoder side or coded data associated with the current block to be decoded at a decoder side;
determine mode-type prediction, wherein the mode-type prediction is generated by using target prediction mode information from candidate prediction mode information, wherein the candidate prediction mode information comprises filter-based intra prediction information;
determine second prediction generated by an inter mode or an IBC (Intra Block Copy) mode;
determine combined prediction by using the mode-type prediction and the second prediction with blending weights; and
encode or decode the current block using the combined prediction.
